(19) United States
(12) Patent Application Publication
(10) Pub. No.: US 2009/0013508 A1
(43) Pub. Date: Jan. 15, 2009

(54) Adapter system for the detachable fastening of objects

(75) Inventors: Bodo zu Putlitz, Hamburg (DE); Udo Dominikat, Wees (DE)

Correspondence Address: NORRIS, MCLAUGHLIN & MARCUS, 875 THIRD AVE, 18TH FLOOR, NEW YORK, NY, 10022, US

(73) Assignee: TESA AG, Hamburg (DE)

(21) Appl. No.: 12/146,059

(22) Filed: Jun. 25, 2008

(30) Foreign Application Priority Data
Jul. 11, 2007 (DE) 10 2007 032 641.8

(51) Int. Cl. A47G 1/17; F16B 11/00

(52) U.S. Cl. 24/584.1; 248/475.1; 248/205.3

(57) ABSTRACT

An adapter system for the detachable fastening of objects, with two adapter elements (5), wherein one adapter element (5) can be connected to the object to be fastened and the other adapter element (5) can be connected to the corresponding counterpart, and wherein the two adapter elements (5) can be connected detachably to each other, characterized in that the two adapter elements (5) are of identical design.

### BACKGROUND OF THE INVENTION

(1) Field of the Invention

The present invention relates to an adapter system for the detachable fastening of objects, according to the precharacterizing clause of claim 1, to adapter elements of an adapter system of this type, and to the use of the adapter system for the fastening of objects without leaving any residue and without damage.

2) Description of Related Art Including Information Disclosed Under 37 CFR 1.97 and 1.98

It is known from the prior art to use an adapter system for the fastening of objects without leaving any residue and without damage. Adhesive films which are re-detachable by pulling in the bonding plane are particularly suitable in conjunction with an adapter system for a fastening of this type. Adhesive films of this type are known, for example, as “Power Strips”® from tesa AG. Furthermore, adhesive films of this type, which are detachable by pulling on the adhesive film in the direction of the bonding plane, are described, for example, in DE 33 31 016 A1 and DE 42 22 849 C1.

DE 195 11 288 A1 describes a use in which, in addition to the above-mentioned adhesive films, an adapter system comprising two adapter elements is used. The two adapter elements can each be fastened by means of the adhesive film to an object, such as, for example, a wall and a picture, and can be connected detachably to each other. The detachable connection is obtained by the two adapter elements being connected to each other by means of a latching connection. For this purpose, one adapter element has a latching lug and the other adapter element has a corresponding latching recess.

A further configuration of an adapter system of this type is shown in DE 196 32 182 A1 in which likewise one adapter element of the adapter system is adhesively bonded to a first object and the other adapter element is adhesively bonded to a second object. The two adapter elements are again connected by being detachably plugged together. Further known adapter systems are shown, for example, in EP 0 861 622 B1 and EP 0 896 807 B1.

In the case of the above-described adapter systems known from the prior art, the production is relatively complicated because it requires in particular different tools. The present invention is therefore based on the problem of providing an adapter system which can be used in a versatile manner, but can at the same time also be produced in a simple manner.

### BRIEF SUMMARY OF THE INVENTION

The present invention solves this problem with an adapter system with the features of the precharacterizing clause of claim 1 by means of the features of the characterizing part of claim 1. An adapter element according to claim 22 represents an independent solution. A use according to the invention of the adapter system is described in claim 23. Preferred developments are the subject matter of the respective subclaims.

Of significance, firstly, for the adapter system according to the invention is the finding that two identical adapter elements can be combined to form an adapter system without the functionality of the adapter system as such being impaired. An identical configuration of the adapter elements signifies a great simplification for the production of an adapter system of this type, since, rather than having to keep tools ready for different elements, the same tool can be used. As a result, the extent to which the tool is used for the adapter element is increased such that, even if the adapter element is relatively complex, the production thereof nevertheless remains easier.

In the simplest configuration, one adapter element can be pushed into the other such that, in the installation situation, the two adapter elements are held together solely by gravitational force. The customary use of an adapter system of this type is referred to here as the installation situation. In this situation, one adapter element is fastened to a first object (for example a wall), the second adapter element is connected to the first adapter element and, if appropriate, a second object (for example a hook) is also fastened to the second adapter element. The fastening of the objects to the respective adapter element preferably takes place by means of detachable adhesive film sections, but, depending on the configuration, may also take place by means of a latching connection, screw connection or the like.

In a preferred configuration, the adapter elements can be latched to each other. For the latching connection, it is provided in particular that each adapter element has at least one, if appropriate also more than one, latching lug and a corresponding number of latching recesses. In this case, the latching lugs and latching recesses are arranged on the adapter element in such a manner that, in the installation situation, i.e. when the adapter elements are latched to each other, the latching lugs of the one adapter element engage in the latching recesses of the other adapter element.

In a preferred configuration, the adapter element has a rear angled portion on a first side, in particular on its end side, and is thus divided into a basic region and a first angled region. The angled region and basic region are of approximately C-shaped design in cross section. The angled portion preferably amounts to essentially 180°. Owing to the angled portion, there is a clearance between the basic region and the first angled region. In a preferred configuration, the clearance has a height which corresponds at least to the thickness of the adapter element at its opposite end such that the second adapter element can be pushed into this clearance during the connection of the two adapter elements. If the thickness essentially corresponds to the thickness of the adapter element itself and is not designed to be significantly greater, the adapter system is also secured against tilting in the installation situation.

It is furthermore preferred if, on a second side, in particular lying opposite the first end side, the adapter element has a stepped angled portion with a second angled region. In the installation situation, this second angled region then extends into the rear angled portion in the first angled region. For an arrangement of this type, it is provided that the height of the stepped angled portion, i.e. the step height, also essentially corresponds to the thickness of the adapter element. Furthermore, the lengths of the first angled region and second angled region should be essentially identical.

In particular by means of the two above-described angled regions, the adapter system can be designed in such a manner that it has essentially flat contact surfaces. The surfaces which, in the installation situation, are in contact with the objects to be fastened are referred to as the contact surfaces. These surfaces should accordingly not have any curvatures, i.e. should be of flat design. By contrast, relatively small recesses are less disturbing.

In a further preferred configuration, it is provided that, in the installation situation, the basic regions of the two adapter elements are essentially spaced apart from each other. The distance is such that the two basic elements do not come into contact with each other and rub against each other during the connection of the two adapter elements, and therefore the connection can accordingly be carried out easily. The contact surface of the two adapter elements is kept small in particular during the connection.

With regard to the arrangement of latching lug and latching recess, it is particularly preferred if they are arranged in the angled regions. An arrangement of latching lug and latching recess in these regions is particularly advantageous for a simple manual release of the latching connection.

Furthermore, each adapter element should have a guide for the connection of the two adapter elements. The guide serves to make it easier for the user to connect the two adapter elements and serves to essentially prevent misoperation, for example due to the adapter elements tilting. Furthermore, the guide can optionally serve in the installation situation for fixing purposes, i.e. in particular for securing against lateral and/or axial tipping. Guides of this type are preferably formed by one or more bent portions on the adapter element. Bent portions can be realized without a large outlay. In the situation in which the adapter element is composed of metal, it is possible, for example, for a lateral border to be appropriately crimped.

Depending on the configuration of the adapter element, the guide element can be formed just on one or else on more longitudinal sides. In particular in the case of a configuration with the above-described angled regions, a guide on both longitudinal sides is advantageous. The guide should then only extend in each case at maximum as far as the centre of the adapter element so that the guides of the two adapter elements do not obstruct the connection of the same to each other.

The adapter element itself can be produced, for example, from metal or plastic. In this case, the adapter element can be produced as a single piece or can be composed of a plurality of elements with different materials. However, in particular in the case of a configuration made of plastic, a single-piece design of the adapter element is particularly advantageous.

### BRIEF DESCRIPTION OF THE SEVERAL VIEWS OF THE DRAWING(S)

Further details, features, aims and advantages of the present invention are explained in more detail below with reference to a drawing of preferred exemplary embodiments. In the drawing:

FIGS. 1-3 show a previously known adhesive bond,

FIG. 4 shows a side view of the adapter system shortly before and during the installation situation,

FIG. 5 shows a perspective view of an adapter element of the adapter system from FIG. 4,

FIG. 6 shows alternative configurations of the adapter element from FIG. 5.

### DETAILED DESCRIPTION OF THE INVENTION

FIG. 1 shows a known adhesive film which is commercially obtainable under the name “Power Strips”®. Said adhesive film comprises an adhesive compound (1) with a grip tab (2) and a respective covering paper (3) on both sides of the adhesive compound (1). The grip tab is formed here by means of coverings arranged on both sides at one end of the adhesive compound (1).

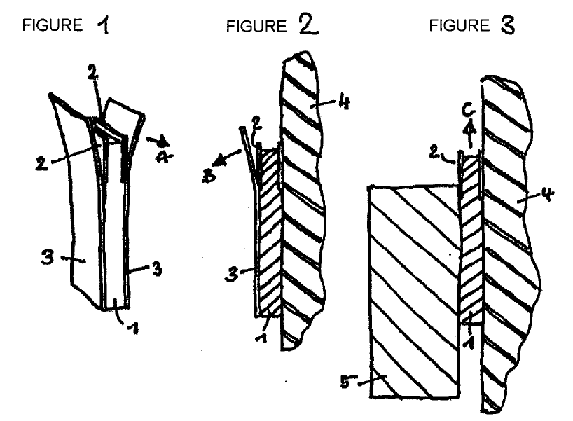

If the one covering paper (3) is pulled off in the direction of the arrow (A), then one side of the adhesive compound (1) is exposed. The adhesive film can be adhesively bonded by said adhesive side to an underlying surface, for example a wall (4), as illustrated in FIG. 2. The other covering paper (3) can then be pulled off in the direction of the arrow (B), and the adhesive side located there below is exposed. An object (5), for example an adapter element, can be adhesively bonded thereto in such a manner that the grip tab (2) protrudes out of the adhesive joint. An adhesive bond which is fixed, capable of bearing loads and is durable is achieved but can be re-detached without leaving any residue by pulling on the grip tab (2) in the direction of the arrow (C), as illustrated in FIG. 3. In the process, only the object (5) should be held or secured such that it does not ultimately drop down and become damaged. This technique which is illustrated in FIGS. 1-3 is well known.

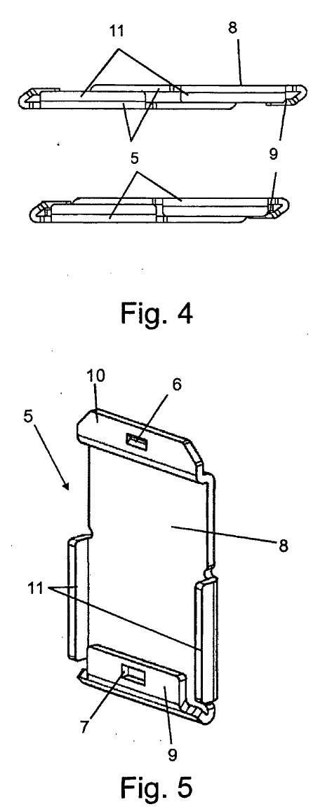

FIG. 4 shows an adapter system which can be used in conjunction with the above-described adhesive film for fastening objects, such as, for example, strips of hooks, to a wall without leaving any residue and without damage, or for the detachable, reusable connection of any other objects desired. The use of the already known adhesive film enables a correspondingly fastened object to easily be detached again without damage. In this case, this type of fastening can take place just on one side, for example just to a wall or to another object, or on both sides, i.e. to both objects which are to be connected to each other.

For this purpose, the adapter system has two identical adapter elements (5). One of these adapter elements (5) is illustrated in a perspective view in FIG. 5. The two adapter elements (5) can be connected detachably to each other, with the simplest connection being obtained merely by the two adapter elements (5) being plugged one inside the other. However, FIGS. 4, 5 show a preferred configuration in which the two adapter elements (5) can be latched to each other. For this purpose, the adapter element (5) has a latching lug (6) and a latching recess (7). The latching lug (6) and the latching recess (7) are each arranged in such a manner that, in the installation situation, i.e. when the two adapter elements (5) are latched to each other, the latching lug (6) of the first adapter element (5) engages in the latching recess (7) of the other adapter element (5), and vice versa.

It is apparent in particular from FIG. 5 that the adapter element (5) has a rear angled portion on one end side. This angled portion divides the adapter element (5) into a basic region (8) and a first angled region (9). The angled portion of the first angled region (9) amounts here and preferably to essentially 180°. Owing to the fact that the angled portion is directed rearward, the adapter element (5) is of approximately C-shaped design in cross section in this region. There is therefore a clearance between the angled region (9) and the basic region (8). The height of this clearance is designed in such a manner that it essentially corresponds to the thickness of the adapter element (5). In the installation situation, the second adapter element (5) can be pushed into said clearance such that, just by means of the angled portion, a first fixing of the two adapter elements (5) to each other takes place.

In addition, the adapter element (5) has a stepped angled portion on a second end side lying opposite the first end side, and thus forms a second angled region (10). In contrast to the first angled region (9), the angled portion is not directed rearward, but rather forward and therefore extends the entire length of the adapter element (5). The height of the step-shaped angled portion corresponds here and preferably essentially to the thickness of the adapter element such that, in the installation situation, the adapter system is of essentially flat design on its contact sides. This simplifies the attaching of the above-described adhesive films.

In order to make the installation of the two adapter elements (5) as simple as possible and at the same time also to provide the flat contact surfaces, the first angled region (9) and second angled region (10) are essentially identical in length. In addition, a spacing-apart of the basic regions (8) of the two adapter elements (5) in the installation situation is realized by means of the two angled portions. As a result, the two adapter elements (5) can be connected particularly simply to each other, since only small frictional forces have to be overcome during the connection.

As has already been described above, the latching of the two adapter elements (5) takes place by means of latching lugs (6) and corresponding latching recesses (7). In the present case, it is provided that the latching lug (6) is provided on the second angled region (10), in particular below the angled portion, and the latching recess (7) is provided in the first angled region (9). The arrangement of latching lug and latching recess in the respective angled regions has proven particularly advantageous for the connection of the two adapter elements (5) to each other.

FIG. 5 shows a lateral guide (11) which is intended to simplify the connection of the two adapter elements (5) to each other. The guide (11) is formed here by a bent portion through essentially 90° on both longitudinal sides of the adapter element (5). In this case, the guide (11) does not extend over the entire length of the adapter element (5) but rather only approximately as far as the centre thereof. The bent portion emerges from the basic region (8) of the adapter element (5). Since the bent portions for the first angled region (9) and the second angled region (10) also emerge from the basic region (8), the adapter element (5), if it is composed of metal, can be produced as a single piece by crimping the corresponding edges. In the case of a configuration of the adapter element (5) from plastic, the latter can likewise be produced as a single piece, for example by injection moulding.

It cannot be gathered from the present figures that the adapter element (5) has a channel on its lower side in the basic region (8). Said channel preferably extends over the entire length of the basic region (8) in the longitudinal direction. Said channel serves, when the adapter system is used with an adhesive film, to allow air to escape during the adhesive bonding as the adapter element (5) is connected to the adhesive film and therefore to permit a neat, blister-free adhesive bond.

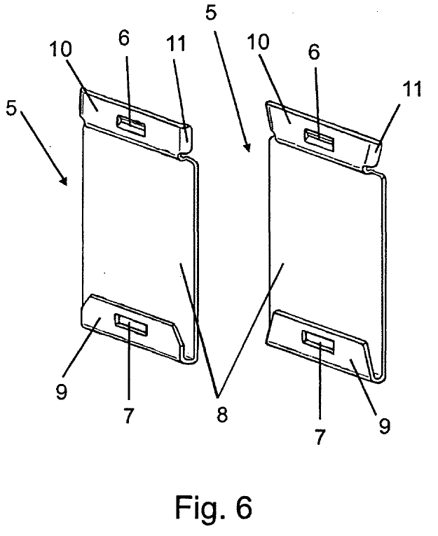

FIG. 6 shows alternative configurations of the adapter element (5). In contrast to the previous configuration, in these configurations the guide (11) is not arranged on the basic region (8) but rather only on the second angled region (10). The guide (11) is therefore formed by a matching configuration of the two angled regions (9, 10) with respect to each other. For this purpose, in the first alternative configuration, the two regions are of essentially rectangular design and, in the second alternative configuration, are of essentially trapezoidal design.

1. An adapter system for the detachable fastening of objects, comprising
a first and a second adapter element;
the first adapter element is capable of being connected to the object to be fastened;
the second adapter element is capable of being connected to a corresponding counterpart,
wherein the first and the second adapter elements are capable to being connected detachably to each other, and wherein the first and the second adapter elements are of identical design.

2. The adapter system according to claim 1, wherein the first and the second adapter element are capable of being latched to each other.

3. The adapter system according to claim 2, wherein the first and the second adapter element have at least one latching lug and a latching recess, the latching lug of the first adapter element being arranged such that it engages in the latching recess of the second adapter element as the latching connection is made.

4. The adapter system according to claim 1, wherein the first adapter element has a rear angled portion on a first side, and the first adapter element thus has a basic region and a first angled region.

5. The adapter system according to claim 4, wherein a clearance id disposed between the first angled region (9) and the basic region (8), and the clearance has a height which essentially corresponds to the thickness of the adapter element (8).

6. The adapter system according to claim 1, wherein on a second side, preferably lying opposite the first side, the adapter has a stepped angled portion with a second angled region.

7. The adapter system according to claim 6, wherein the height of the stepped angled portion essentially corresponds to the thickness of the adapter element (5).

8. The adapter system according to claim 6, wherein the first angled region and second angled region are essentially identical in length.

9. The adapter system according to claim 1, wherein the adapter system is designed such that, during installation the adapter system has an essentially flat contact surfaces.

10. The adapter system according to claim 1, wherein during installation, the basic regions of the first and the second adapter elements are spaced apart from each other.

11. The adapter system according to claim 10, wherein the latching lug or the latching recess is arranged in the first angled region and the latching recess or the latching lug is correspondingly arranged in the second angled region.

12. The adapter system according to claim 11, wherein the first angled region is of trapezoidal design.

13. The adapter system according to claim 12, wherein the adapter element has a guide for the connection of the two adapter elements.

14. The adapter system according to claim 13, wherein the guide is formed by one or more bent portions, preferably of essentially 90°.

15. The adapter system according to claim 13, wherein the guide is formed on one or more longitudinal sides.

16. The adapter system according to claim 15, wherein the guide extends at maximum over half the length of the adapter element.

17. The adapter system according to claim 13, wherein the guide is formed in the basic region of the first adapter element.

18. The adapter system according to claim 17, wherein the guide is formed in the region of the first and/or second angled region.

19. The adapter system according to claim 17, wherein the adapter element is designed as a single piece.

20. The adapter system according to claim 19, wherein the adapter element is produced from metal and/or plastic.

21. The adapter system according to claim 20, wherein the adapter element has a channel on its lower side in the basic region.

22. An adapter system including a adapter element according to claim 1.

23. A method of using an adapter system according to claim 1 for the fastening of objects without leaving any residue and without damage, wherein an adhesive film which can be re-detached without leaving any residue and without damage is attached to the lower side at any rate of one of the adapter elements and the adapter element is attached to the object by said adhesive film.

24. The adapter system according to claim 1, wherein the first adapter element has a rear angled portion, preferably through essentially 180°, on a first side, in particular its end side, and the adapter element thus has a basic region and a first angled region.

25. The adapter system according to claim 12, wherein the second angled region is of trapezoidal design.
